(19) United States
(12) Patent Application Publication
(10) Pub. No.: US 2015/0131814 A1
(43) Pub. Date: May 14, 2015

(54) METHOD AND SYSTEM FOR CONTACT SENSING USING COHERENCE ANALYSIS

(71) Applicants: John Usher, Beer (GB); Steve Goldstein, Delray Beach, FL (US); Jason McIntosh, SugarHill, GA (US)

(72) Inventors: John Usher, Beer (GB); Steve Goldstein, Delray Beach, FL (US); Jason McIntosh, SugarHill, GA (US)

(73) Assignee: Personics Holdings, Inc., Boca Raton, FL (US)

(21) Appl. No.: 14/079,506

(22) Filed: Nov. 13, 2013

(51) Int. Cl. H04R 29/00; H04R 1/08

(52) U.S. Cl. CPC H04R 29/00; H04R 1/08
USPC 381/123

(57) ABSTRACT

Herein provided is a method for acoustical switching suitable for use with a microphone enabled electronic device. The method includes capturing a first microphone signal from a first microphone on a device, analyzing the first microphone signal for a contact event versus a non-contact event, and directing the electronic device to switch a processing state responsive to detection of either the contact event or non-contact event. In another configuration, additional microphone can be added for performing coherence analysis between at least two microphone signals mounted on or in the device. At least one parameter settings of the device can be changed in response to at least one detected physical contact on the device. Other embodiments are disclosed.

### FIELD

The present invention relates to user interactive electronic devices, and more particularly, though not exclusively, to acoustic detection of a physical input for operating a microphone enabled electronic device.

### BACKGROUND

Most media based electronic devices are operated by way of a user interface. As devices become smaller there is only limited space for the user interaction and the user is generally required to physically interact with the device, for example, by way of a touch screen. This size limitation for user interaction is more evident with smaller devices, such as earpieces and smart wristwatches.

The microphones and speakers on such media devices are primarily used for capturing voice and producing sound output. Silicon analog and digital microphones are increasingly affordable and common in a variety of mobile electronic devices. These microphones are generally configured as speech sensors; for detecting speech for purposes of voice control of a device or for voice communication or recording with the device. Multiple microphones on a device offer advantages for improving the quality of detected speech using active noise reduction systems.

There are certain configurations with microphones that permit for user interaction from processing of sound waves instead of physical interaction with the user interface. U.S. Patent Application 2011/0142269 A1 describes a hearing aid switch that utilizes pressure/sound clues from a filtered input signal to enable actuation initiated by a user by a signature hand movement relative to a wearer's ear. The preferred signature hand movement involves patting on the ear meatus at least one time to generate a compression wave commonly thought of as a soft “clap” or “pop”. A digital signal processor analyzes the signal looking for a negative pulse, a positive pulse, and dissipation of the hand generated signal. U.S. Pat. No. 8,358,797 describes a method for changing at least two parameter settings of a device and includes detecting an abnormal change in an external feedback path and an input signal generated by an abnormal pressure wave, and activating a pressure wave detection switch and an abnormal feedback path detection switch for changing the at least one parameter setting in the device.

These methods are however prone to false detections and can degrade the user experience. There remains a need to improve upon the manner by which existing microphones can be leveraged to enhance and make the user interface experience more robust.

### SUMMARY

In one embodiment a method for acoustical switching suitable for use with a microphone enabled electronic device is provided. The method can include the steps of capturing a first microphone signal from a first microphone on a device, by way of a processor on the device communicatively coupled to the first microphone: analyzing the first microphone signal for a contact event versus a non-contact event; and directing the electronic device to switch a processing state responsive to a detection of either the contact event or non-contact event. The processing state responsive to detecting the contact event, but not so limited, can comprise at least one of performing a user interface action, a command response, an automatic interaction or a recording. The processing state responsive to detecting the non-contact event, but not so limited, can comprise at least one of a voice communication, a data communication, an event detection, a speech recognition or a key word detection.

In one configuration, the method for contact sensing can further include capturing a second microphone signal from a second microphone on the device, and by way of the processor on the device communicatively coupled also to the second microphone: perform a coherence function on the first microphone signal and the second microphone signal, analyze the coherence function to determine if a physical contact due to touch occurred on the device, and provide a change to at least one parameter setting on the electronic device responsive to determining the physical contact occurred. The method includes discriminating between the physical contact with a high inter-microphone coherence and an airborne event with a low inter-microphone coherence.

The method can further include generating a smoothed coherence function from the coherence function, resolving a peak in the smoothed coherence function; comparing the peak in the smoothed coherence function to a threshold; and deciding the physical contact has occurred if the peak is greater than the threshold. The method can include resolving one or more peaks in the coherence function; evaluating a time window between the one or more peaks, and setting a contact detection status to a negative value for de-bouncing if the time window is less than a previous time window, otherwise setting the contact detection status to a positive value. This can include counting a number of the contact detection status events for positive values, and differentiating between a single tap and a double tap from analysis of the contact detection status if the number is within a time period.

The method can further include tuning a cavitational acoustic resonance by way of resonant air channels, and reducing sensitivity of the coherence function to an airborne event from the tuned cavitational acoustic resonance of the first and second microphone signals. A spectral notch specific to the airborne sound event can be designed by shaping the resonant air channel to decrease the coherence function for the airborne sound in a frequency band of interest.

### BRIEF DESCRIPTION OF THE DRAWINGS

FIG. 1A illustrates a wearable system for detecting physical contact on a headset device in accordance with an exemplary embodiment;

FIG. 1B illustrates another wearable system for detecting physical contact on an eyeglass device in accordance with an exemplary embodiment;

FIG. 1C illustrates a mobile device for coupling with the wearable system in accordance with an exemplary embodiment;

FIG. 1D illustrates another mobile device for coupling with the wearable system in accordance with an exemplary embodiment;

FIG. 1E illustrates an acoustic switch for directing a processing state in accordance with an exemplary embodiment;

FIG. 2 is method for coherence based contact sensing suitable for use with the wearable system in accordance with an exemplary embodiment;

FIG. 3 is flowchart for media setting adjustment and mixing audio signals suitable for use with the wearable system in accordance with an exemplary embodiment;

FIG. 4 is method for detecting a physical tap using coherence analysis suitable for use with the wearable system in accordance with an exemplary embodiment;

FIG. 5 depicts magnitude coherence functions in accordance with the exemplary embodiments for detecting a contact;

FIG. 6 depicts spectral waveforms used in conjunction with coherence functions in accordance with the exemplary embodiments for detecting a contact;

FIG. 7A depicts a block diagram configuration of coherence based contact system for activating audio recordings in accordance with an exemplary embodiment;

FIG. 7B depicts a block diagram configuration of coherence based contact system using multiple microphones in accordance with an exemplary embodiment;

FIG. 7C depicts another block diagram configuration of coherence based contact system using multiple microphones in accordance with an exemplary embodiment;

FIG. 8A illustrates a device body configured with acoustic ports for microphone based coherence analysis in accordance with an exemplary embodiment;

FIG. 8B illustrates a device body configured with a cavitation for microphone based coherence analysis in accordance with an exemplary embodiment;

FIG. 8C illustrates a frequency response for the device body for FIG. 8A and FIG. 8B in accordance with an exemplary embodiment;

FIG. 9A is an exemplary earpiece for use with the coherence based contact system of FIG. 1A in accordance with an exemplary embodiment; and

FIG. 9B is an exemplary mobile device for use with the coherence based contact system of FIG. 1A in accordance with an exemplary embodiment.

### DETAILED DESCRIPTION

The following description of at least one exemplary embodiment is merely illustrative in nature and is in no way intended to limit the invention, its application, or uses. Similar reference numerals and letters refer to similar items in the following figures, and thus once an item is defined in one figure, it may not be discussed for following figures.

Herein provided is a method and system for detecting a physical contact on a device using the analysis of the coherence between at least two microphones mounted on or in the device. At least one parameter settings of the device can be changed in response to at least one detected physical contact. The system analyzes a coherence between the microphone signals generated by the physical contact to discriminate if physical contact occurred. It can differentiate between a purposely initiated contact for such control or whether it was a non-initiated airborne sound. The user can simply perform a tap or tapping on the device to control a media setting, for example an adjustment function to control a volume. Other functions are herein contemplated.

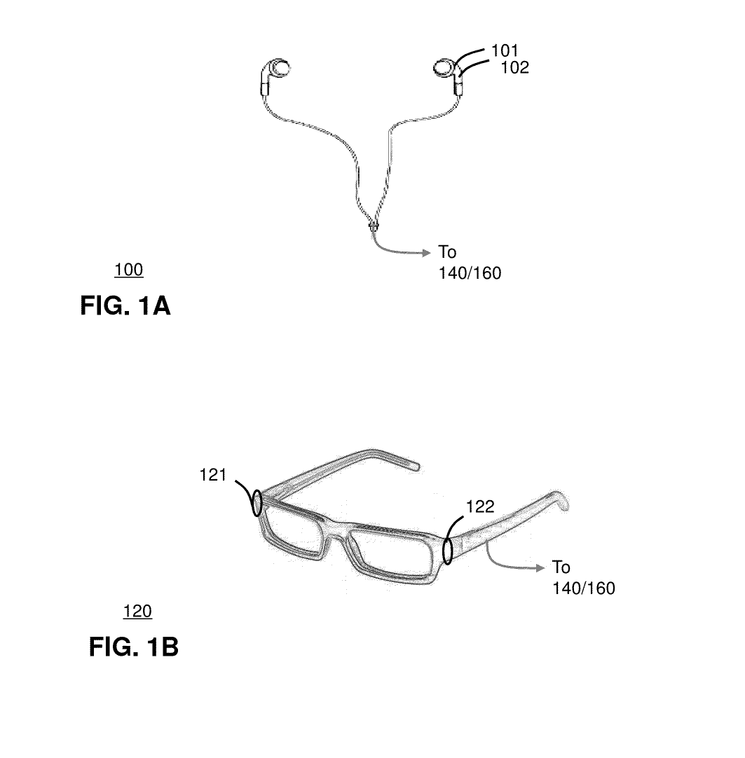

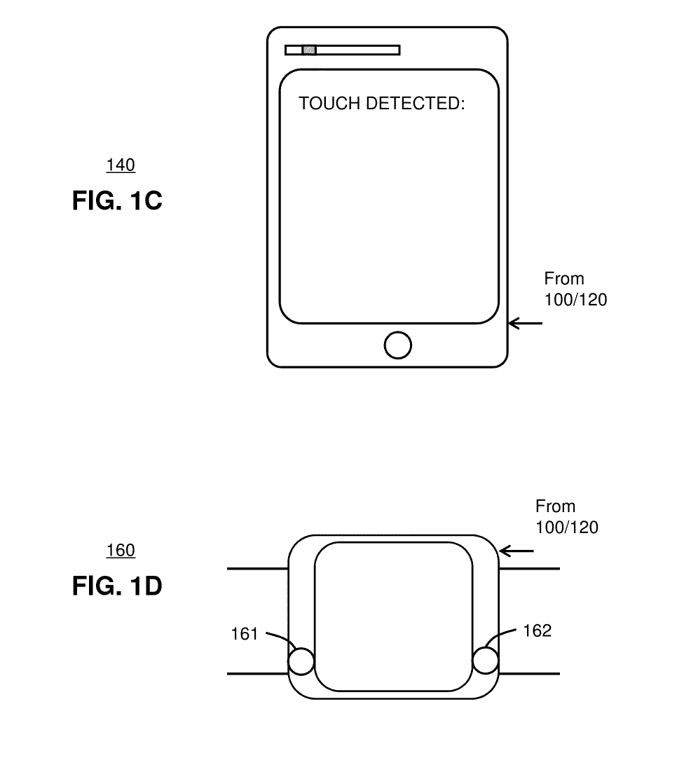

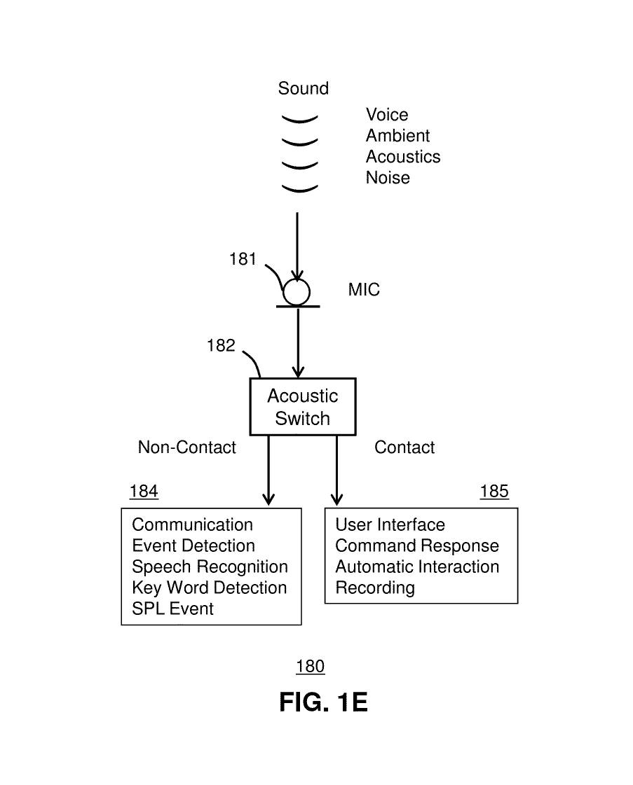

Referring to FIG. 1A, a system 100 for detecting physical contact on a device in accordance with a headset configuration is shown. In this embodiment, wherein the headset operates as a wearable computing device, the system 100 includes a first microphone 101 for capturing a first microphone signal, a second microphone 102 for capturing a second microphone signal, and a processor 140/160 communicatively coupled to the first microphone 101 and the second microphone 102 to perform a coherence analysis to determine if a physical contact occurred on the device. As will be explained ahead, the processor 140/160 may reside on a communicatively coupled mobile device or other wearable computing device for sensing a physical contact on the headset device, for example, a finger tap or touch of one of the earpieces. Tapping on the headset (or other wearable device), due to the mechanically coupled microphones, produces a high inter-microphone coherence. In contrast, as will be described ahead, airborne sound events near the two microphones that could spur false contact detections will generally give a lower inter-microphone coherence. By analysis of the inter-microphone coherence and detection of a high peak in the coherence, the present system 100 generates commands to control the device, for example, in this embodiment, to change at least one parameter setting of the device, such as a media control of the headset (e.g., volume, play list, balance, etc.).

The system 100 can be configured to be part of any suitable media or computing device. For example, the system may be housed in the computing device or may be coupled to the computing device. The computing device may include, without being limited to wearable and/or body-borne (also referred to herein as bearable) computing devices. Examples of wearable/body-borne computing devices include head-mounted displays, earpieces, smartwatches, smartphones, cochlear implants and artificial eyes. Briefly, wearable computing devices relate to devices that may be worn on the body. Bearable computing devices relate to devices that may be worn on the body or in the body, such as implantable devices. Bearable computing devices may be configured to be temporarily or permanently installed in the body. Wearable devices may be worn, for example, on or in clothing, watches, glasses, shoes, as well as any other suitable accessory.

It should be noted that the devices (e.g, headphones, eyeglasses, etc.) configured for use by the system 100 may not be in direct sight of the user. Accordingly, touch and feel is an intuitive means for interacting with the wearable computing device, and so the tapping need occur only somewhere on the body (outer plastic casing, shell, etc.) of the device within mechanical coupling vicinity of the first 101 and second 102 microphones. That is, the user is not required to identify and tap an individual microphone, but rather, tap within proximity of the microphones on the device in a region that the microphones are mechanically coupled for propagation of acoustic signals there through, as will be explained ahead. By way of this mechanical coupling of the two microphones the system 100 can resolve whether the tapping is a physical tapping initiated by a user and/or differentiate between airborne sounds which are not initiated by the user, for example, abrupt noises or loud sounds. Although only the first 101 and second 102 microphone are shown together on a right earpiece, the system 100 can also be configured for individual earpieces (left or right) or include an additional pair of microphones on a second earpiece in addition to the first earpiece. The system 100 can be configured to be optimized for different microphone spacing's and different microphone housing materials as will be described ahead.

Referring to FIG. 1B, the system 100 in accordance with yet another wearable computing device is shown. In this embodiment, eyeglasses 120 operate as the wearable computing device, for collective processing of acoustic signals (e.g., ambient, environmental, voice, etc.) and media (e.g., accessory earpiece connected to eyeglasses for listening) when communicatively coupled to a media device (e.g., mobile device, cell phone, etc.). In this arrangement, analogous to an earpiece with microphones but rather embedded in eyeglasses, the user may rely on the eyeglasses for voice communication and external sound capture instead of requiring the user to hold the media device in a typical hand-held phone orientation (i.e., cell phone microphone to mouth area, and speaker output to the ears). That is, the eyeglasses sense and pick up the user's voice (and other external sounds) for permitting voice processing. An earpiece may also be attached to the eyeglasses 120 for providing audio and voice.

In the configuration shown, the first 121 and second 122 microphones are mechanically mounted to one side of eyeglasses. Again, the embodiment 120 can be configured for individual sides (left or right) or include an additional pair of microphones on a second side in addition to the first side. Using the first microphone 121 and second microphone 122 to detect when the device is in contact with another object, e.g. to detect a “finger tap”, allows operational parameter settings on the device (e.g. eyeglasses) to be changed without the need for additional contact detecting switches. Similarly, a processor 140/160 communicatively coupled to the first microphone 121 and the second microphone 122 for sensing a physical contact on a device, such as, a finger tap or touch, may be present.

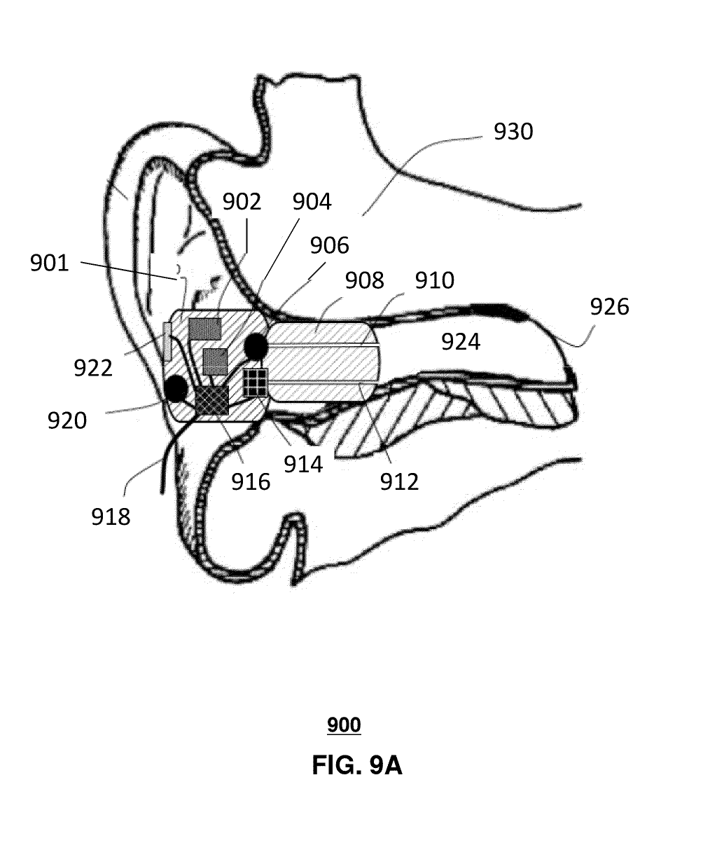

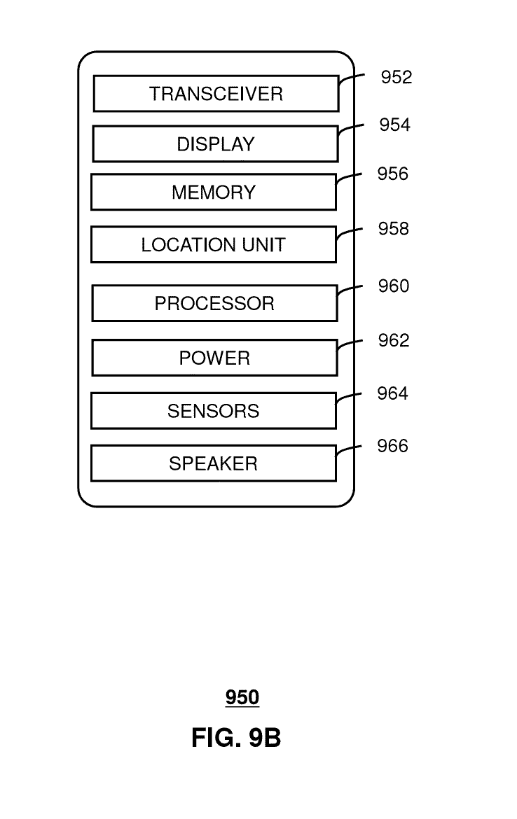

FIG. 1C depicts a first media device 140 as a mobile device (i.e., smartphone) which can be communicatively coupled to either or both of the wearable computing devices (100/120). FIG. 1D depicts a second media device 140 as a wristwatch device which also can be communicatively coupled to the one or more wearable computing devices (100/120). As previously noted in the description of these previous figures, the processor performing the coherence analysis for the detection of a physical touch is included thereon, for example, within a digital signal processor or other software programmable device within, or coupled to, the media device 140 or 160. As will be discussed ahead and in conjunction with FIG. 9B, components of the media device for implementing coherence detection processing functionality will be explained in further detail.

With respect to the previous figures, the system 100 may represent a single device or a family of devices configured, for example, in a master-slave or master-master arrangement. Thus, components of the system 100 may be distributed among one or more devices, such as, but not limited to, the media device illustrated in FIG. 1C and the wristwatch in FIG. 1D. That is, the components of the system 100 may be distributed among several devices (such as a smartphone, a smartwatch, an optical head-mounted display, an earpiece, etc.). Furthermore, the devices (for example, those illustrated in FIG. 1A and FIG. 1B) may be coupled together via any suitable connection, for example, to the media device in FIG. 1C and/or the wristwatch in FIG. 1D, such as, without being limited to, a wired connection, a wireless connection or an optical connection.

The computing devices shown in FIGS. 1C and 1D can include any device having some processing capability for performing a desired function, for instance, as shown in FIG. 9B. Computing devices may provide specific functions, such as heart rate monitoring or pedometer capability, to name a few. More advanced computing devices may provide multiple and/or more advanced functions, for instance, to continuously convey heart signals or other continuous biometric data. As an example, advanced “smart” functions and features similar to those provided on smartphones, smartwatches, optical head-mounted displays or helmet-mounted displays can be included therein. Example functions of computing devices may include, without being limited to, capturing images and/or video, displaying images and/or video, presenting audio signals, presenting text messages and/or emails, identifying voice commands from a user, browsing the web, etc.

Referring to FIG. 1E, a system 180 for acoustical switching suitable for use with a microphone enabled electronic device is shown. The system comprises a first microphone 181 on the device for capturing a first microphone signal, and an acoustic switch 182 communicatively coupled to the first microphone for analyzing the first microphone signal for a contact event versus a non-contact event, and directing the electronic device to switch a processing state responsive to a detection of either the contact event or non-contact event. The microphone signal can arise from a sound source such as voice, ambient sounds, environmental sounds, acoustics, abrupt onsets, acoustic events, noise or any combination thereof. The acoustic switch can be a processor as described herein, and/or a combination of software and hardware as described herein. For example, the acoustic switch can be partially enabled with integrated circuitry for analog processing front-end events, and enabled with digital logic and software programmable devices for back-end processing.

The acoustic switch, by way of a processor on, or operatively coupled to the device, can perform the acoustic switching and/or the processing thereto associated described herein. In one arrangement, the microphone 181 and the acoustic processor 182 reside on the same device, and may be integrated components or joined. In another arrangement, the microphone 181 and the acoustic processor 182 reside on different platforms, for example, a microphone with its own circuitry and communicatively coupled to a mobile device, such as a cell phone. The system 180 can be implemented in whole or in part by the devices shown in FIGS. 9A and 9B described herein, and with respect to the foregoing methods, though are not limited to such components or configurations and may include more or less than the number of components shown.

Responsive to detecting a non-contact or contact event, the acoustic switch directs the processing to a respective state. The processing state 184 responsive to detecting the non-contact event comprises at least one of a voice communication, a data communication, an event detection, a speech recognition or a key word detection. The processing state 185 responsive to detecting the contact event comprises at least one of performing a user interface action, a command response, an automatic interaction or a recording.

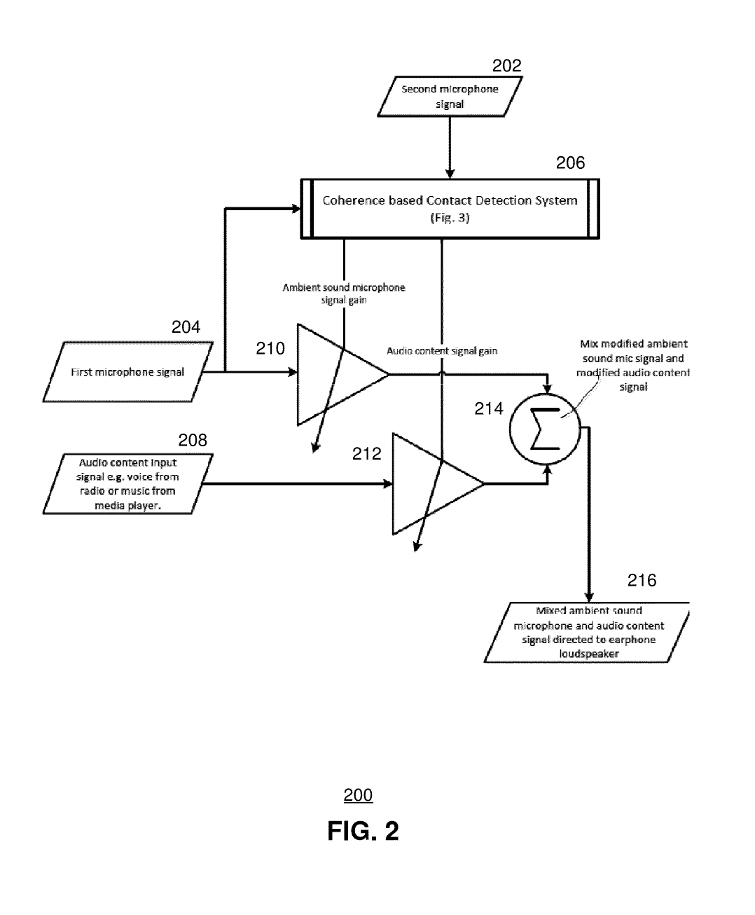

Referring now to FIG. 2, a general method 200 for contact sensing using coherence analysis is shown. The method 200 may be practiced with more or less than the number of steps shown. When describing the method 200, reference will be made to certain figures for identifying exemplary components that can implement the method steps herein. Moreover, the method 200 can be practiced by the components presented in the figures herein though is not limited to the components shown. The reader is also directed to the description of FIG. 9A for a detailed view and description of the components of the earpiece 900 (which may be coupled to the media device 950 of FIG. 9B); components which may be referred to for describing method 200.

Briefly, the method 200 for detecting physical contact is directed to controlling the functionality of a sound isolating earphone using at least two microphones mounted on the body the earphone. As shown in FIG. 9A an exemplary Sound isolating (SI) earphone that is suitable for use with the contact based coherence sensing system 100. Sound isolating earphones and headsets are becoming increasingly popular for music listening and voice communication. SI earphones enable the user to hear and experience an incoming audio content signal (be it speech from a phone call or music audio from a music player) clearly in loud ambient noise environments, by attenuating the level of ambient sound in the user ear-canal. The disadvantage of such SI earphones/headsets is that the user is acoustically detached from their local sound environment, and communication with people in their immediate environment is therefore impaired: i.e. the earphone has a reduced situational awareness due to the acoustic masking properties of the earphone.

Besides acoustic masking, a non Sound Isolating (SI) earphone can reduce the ability of an earphone wearer to hear local sound events as the earphone wearer can be distracted by incoming voice message or reproduced music on the earphones. With reference now to the components of FIG. 9A, the ambient sound microphone (ASM) located on an SI or non-SI earphone can be used to increase situation awareness of the earphone wearer by passing the ASM signal to the loudspeaker in the earphone. Such a “sound pass through” utility can be activated manually using a simple and intuitive mechanism: by detecting a physical contact on the earphone, i.e. an earphone “tap”, “thump” or “bang”. In such a sound pass through mode on a utility, the directional sensitivity of the earphone unit to sound in the wearer's environment can be affected if more than one ambient microphones are used, e.g. using “beam forming” algorithms that require at least two microphones. It is intuitive for the user to use the ambient sound microphones on an earphone to detect a physical user contact (e.g. a finger tap) on the earphone, and to activate a sound pass-through in response to this tap. An analysis of the electronic coherence between the two microphone signals provides a robust means to detect physical contact, as described herein.

Although the method 200 may be practiced solely by the components of the earpiece device, as previously noted, the processing steps may be shared with a communicatively coupled wearable device, such as the mobile device 140 shown in FIG. 1C, or the wristwatch 160 shown in FIG. 1D. The earpiece 900 is connected to a voice communication device (e.g. mobile telephone, radio, computer device) and/or audio content delivery device (e.g. portable media player, computer device). The communication earphone/headset system comprises a sound isolating component for blocking the users ear meatus (e.g. using foam or an expandable balloon); an Ear Canal Receiver (ECR, i.e. loudspeaker) for receiving an audio signal and generating a sound field in a user ear-canal; at least one ambient sound microphone (ASM) for receiving an ambient sound signal and generating at least one ASM signal; and an optional Ear Canal Microphone (ECM) for receiving an ear-canal signal measured in the user's occluded ear-canal and generating an ECM signal. A signal processing system receives an Audio Content (AC) signal (e.g. music or speech audio signal) from the said communication device (e.g. mobile phone etc) or the audio content delivery device (e.g. music player); and further receives the at least one ASM signal and the optional ECM signal. The signal processing system mixes the at least one ASM and AC signal and transmits the resulting mixed signal to the ECR in the loudspeaker.

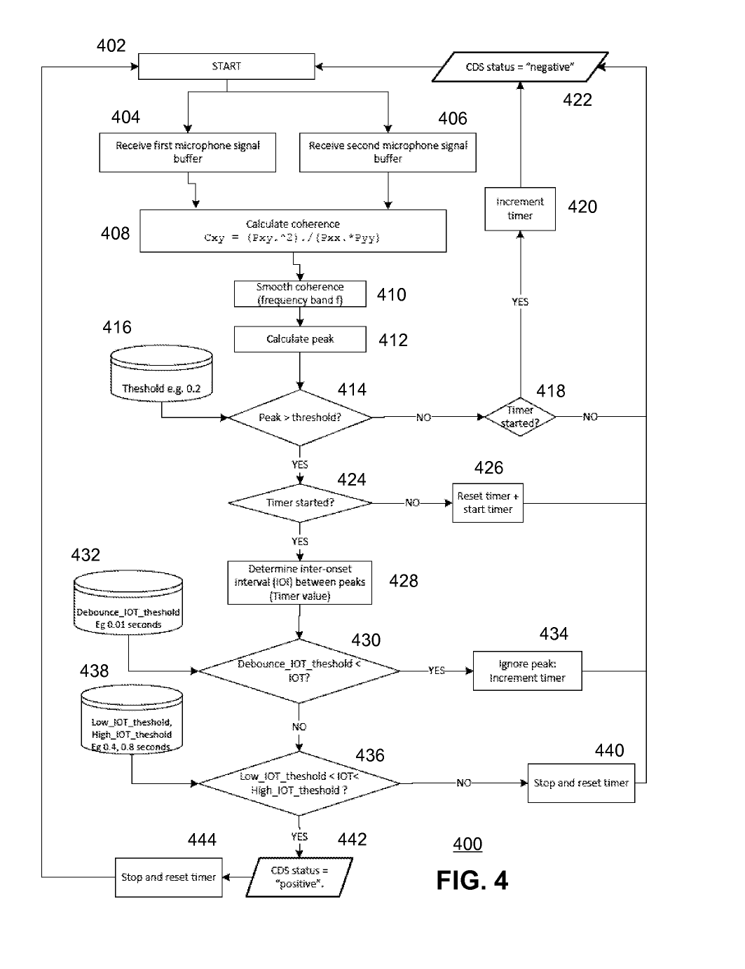

The method 200 can start in a state in which the earpiece 900 is in the user's ear and is actively monitoring for a physical contact, such as a tapping sound. The first microphone and the second microphone capture a first signal and second signal respectively at step 202 and 204. The order of the capture for which signal arrives first is a function of the sound source location; it not the microphone number; either the first or second microphone may capture the first microphone signal. At step 206 the coherence based contact detection system analyzes a coherence between the two microphone signals to determine if a physical tap has occurred. The specifics of this method step are discussed in greater detail ahead in the description of FIG. 4. For now it is sufficient to know that when a peak in the smoothed coherence is detected, a user finger tap is determined to have occurred. In this preferred embodiment, when a “double-tap” is detected, a change of at least one parameter is provided. For instance, the earpiece 900 adjusts the sound microphone signal gain in step 210 responsive to the coherence. Similarly, the earpiece 900, or associated device 950 (e.g. mobile device, wristwatch, etc.) providing media content to the earpiece 900 may also be directed to adjust the audio content signal gain at step 212 responsive to the tap detection. In this preferred embodiment, the mixing of the at least one ASM and AC signal is controlled by ASM and AC signal gains as illustrated. These two signal paths, comprising the ambient sound microphone signal and the audio content signal are then mixed at step 214 and directed to the loudspeaker in the earphone device at step 216. The ASM and AC signal gains are determined by logic incorporating an analysis of the coherence between two ASM signals on the earphone device to detect contact.

It should be noted that the method 200 is not limited to practice only by the earpiece device 900. Examples of electronic devices that incorporate multiple microphones for voice communications and audio recording or analysis, are listed, as well as an example of a parameter setting that can be adjusted in response to a detected contact:
a. Smart watches. The smart watch can switch to a “display time” mode when contact is detected, and visually display the time for example using a back-lit LED. As described and illustrated in FIG. 1E, the smart watch can implement the acoustic switch 182 for acoustic pickup and directing a processing state for contact versus non-contact events. Furthermore, the acoustic pickup can also be utilized to acquire the speech, conversation SPL level, or other nearby stimuli.
b. Smart “eye wear” glasses. The glasses can be configured to take a photograph using a built in camera when contact is detected. Similarly, as described and illustrated in FIG. 1E, the eyeglasses can implement the acoustic switch 182 for acoustic pickup and directing a processing state for contact versus non-contact events. Furthermore, the acoustic pickup can also be utilized to acquire the speech, conversation SPL level, or other nearby stimuli.
c. Remote control units for home entertainment systems. The remote control device can be configured to change the channel in response to the number of detected contact hits within a defined period of time, for example, “1 hit” in a 2 second window increments the channel, and “2 hits” in a 2 second window decrements the channel playback number. Furthermore, the acoustic pickup can also be utilized to acquire the speech, conversation SPL level, or other nearby stimuli; as such the microphones can be used for voice control of the remote.
d. Mobile Phones. The mobile phone can be configured to enter into a “voice analysis mode” in response to, for example, 2 physical hits, where at least one of the ambient microphones is directed to a speech analysis system to, for example, initiated a phone-call in response to the voice command “call John”.
e. Hearing Aids.
f. Steering wheel to enable a switch or for servicing as a hands-free pickup for a mobile device.
g. Elevator Switch that can also use the acoustic pickup for communication with fire, emergency, maintenance or other
h. In a shoe: the contact detection system can be configured to detect a step, i.e. to act as a pedometer.
i. In the ground, e.g. embedded in earth or concrete.
j. Mounted on a freestanding structure designed to restrict or prevent movement across a boundary, e.g. fence or wall. The acoustic pickup can be used to detect voices or other stimuli.

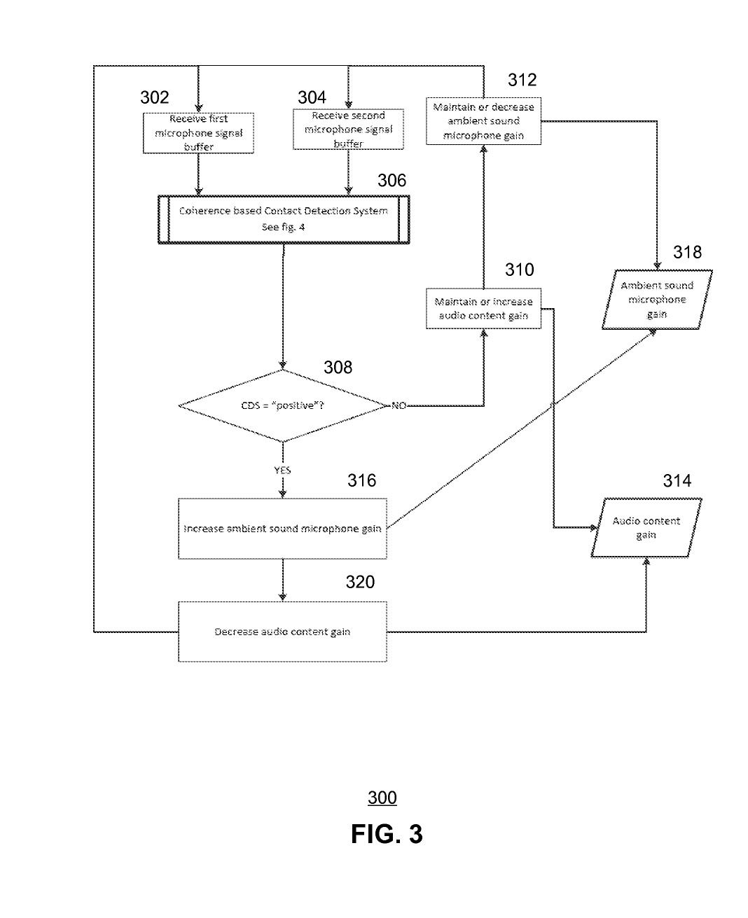

FIG. 3 illustrates an exemplary flowchart 300 for mixing the Ambient Sound Microphone (ASM) and Audio Content (AC) signal gain responsive to detected physical contact on the earpiece (earphone) device 900 as practiced by method 200 of FIG. 2. The steps of the flowchart 300 may be practiced by the components of the earpiece device shown in FIG. 9A and/or in conjunction with the components of the devices shown in FIGS. 1C, 1D and 9B.

Similarly, the flowchart 300 can start in a state in which the earpiece 900 is in the user's ear and is actively monitoring for a physical contact, such as a tapping sound. The first microphone and the second microphone capture a first signal and second signal respectively at step 302 and 304. The processor directs the first and second microphone signal buffer to a digital system and analyses the band-limited smoothed magnitude-squared coherence between the two signals. The coherence function is then performed at step 306 on the first and second microphone signals. One or more peaks of the band-limited smoothed magnitude-squared coherence is then determined from the coherence. For now it is sufficient to know that when a peak in the smoothed coherence is detected, a user finger tap is determined to have occurred. The specifics of the peak detection method will be discussed in greater detail ahead in FIG. 4

The output of the coherence based contact detection system of step 306 is a deciding factor for how the processing proceeds. It will be a “positive” or “negative” state based on the comparison at step 308. The peak value output at step 308 is compared with a threshold value, which in the preferred embodiment is equal to 0.2. If the peak value is YES for “CDS=positive” the ambient sound microphone gain is increased at step 316 for the corresponding ASM parameter control 318. This is followed by an applied decrease in the audio content gain at step 320 for the corresponding AC parameter control 314. That is, if the status is “positive”, then the ambient sound microphone gain is increased AND the audio content signal gain is decreased. If however the peak value is NO for “CDS=positive” at step 308, then the audio content gain is maintained or selectively increased at step 310 for the corresponding AC parameter control 314. Thereafter, the ambient sound microphone gain is maintained or decreased at step 312 for the corresponding ASM parameter control 318. That is, if the status is “negative”, then the ambient sound microphone gain is decreased AND the audio content signal gain is selectively determined. Notably, the ordering of the applied parameter change to the AC and ASM is a function of the CDS state to accommodate the user's listening experience. The method 400 continues to monitor the user's environment and adjust the gains as accordingly described in flowchart 400 starting with steps 302 and 304 again.

FIG. 4 depicts a more detailed method 400 to the flowchart 300 shown in FIG. 3. It expands upon the calculation specifics of coherence function of step 308, and more specifically, the fundamental analysis and resulting state of the coherence function for controlling parameters of the device, including for instance the timing and settings for controlling the AC and ASM gains expressed in the flowchart 300 of FIG. 3. The method 400 may repeat some of the steps previously disclosed for completeness. Similarly, the steps of the method 400 may also be practiced by the components of the earpiece device shown in FIG. 9A and/or in conjunction with the components of the devices shown in FIGS. 1C, 1D and 9B.

Similarly, the method 400 can start in a state 402 in which the earpiece 900 is in the user's ear and is actively monitoring for a physical contact, such as a tapping sound. At step 404 a first microphone signal is received from a first microphone on a device. At step 406, a second microphone signal is received from a second microphone on the device. The coherence function is performed on the first microphone signal and the second microphone signal at step 408. It is at this juncture that the system will analyze the coherence function, perform peak detection, and inter-peak timing relations to determine if a physical contact due to touch occurred on the device, and if so, providing a change to at least one parameter setting on the device responsive to determining the physical contact occurred.

The magnitude squared coherence estimate, Cxy as determined in step 408 is a function of the power spectral densities, Pxx(f) and Pyy(f), of x and y, and the cross power spectral density, Pxy(f), of x and y,

$${C}_{xy} ( f ) = \frac{{\vert {P}_{xy} ( f ) \vert}^{2}}{{P}_{xx} ( f ) {P}_{yy} ( f )}$$

The window length for the power spectral densities and cross power spectral density in the preferred embodiment are approximately 3 ms (˜2 to 5 ms). The time-smoothing for updating the power spectral densities and cross power spectral density in the preferred embodiment is approximately 0.5 seconds (e.g. for the power spectral density level to increase from −60 dB to 0 dB) but may be lower to 0.2 ms.

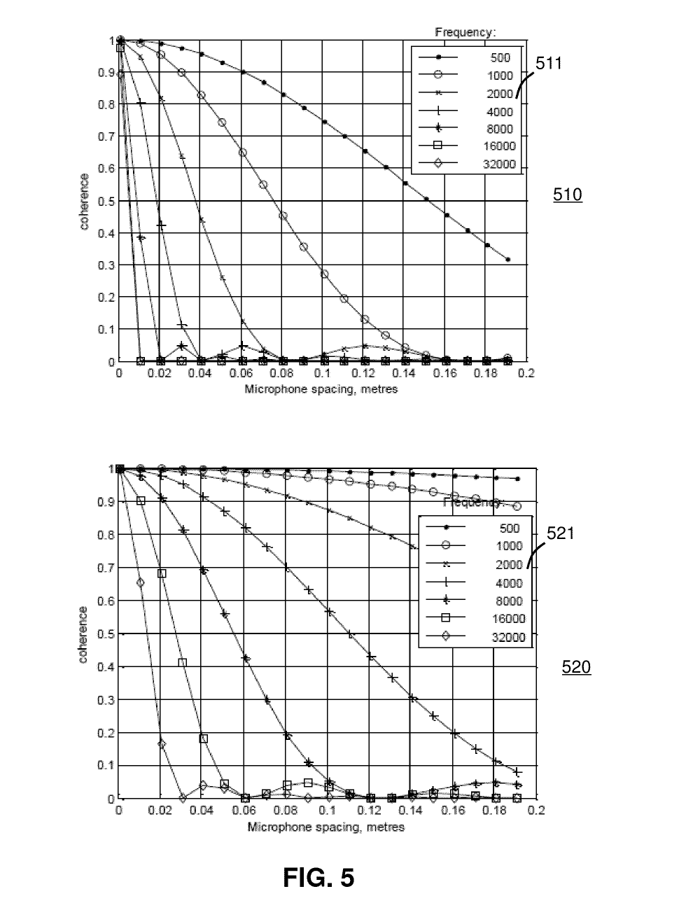

The magnitude squared coherence estimate is a function of frequency with values between 0 and 1 that indicates how well x corresponds to y at each frequency. With regards to the present invention, the signals x and y correspond to the signals from a first and second microphone. The reader is referred to the description of FIG. 5 for a detailed description of the squared coherence between two microphones at different frequencies and different microphone spacings. In the context of method 400, it is sufficient at this juncture that the data in the figures of FIG. 5 are used to determine the frequency at which the coherence is analyzed to detect a physical contact (e.g. “tap”) on the body housing the microphones dependent on the microphone spacings.

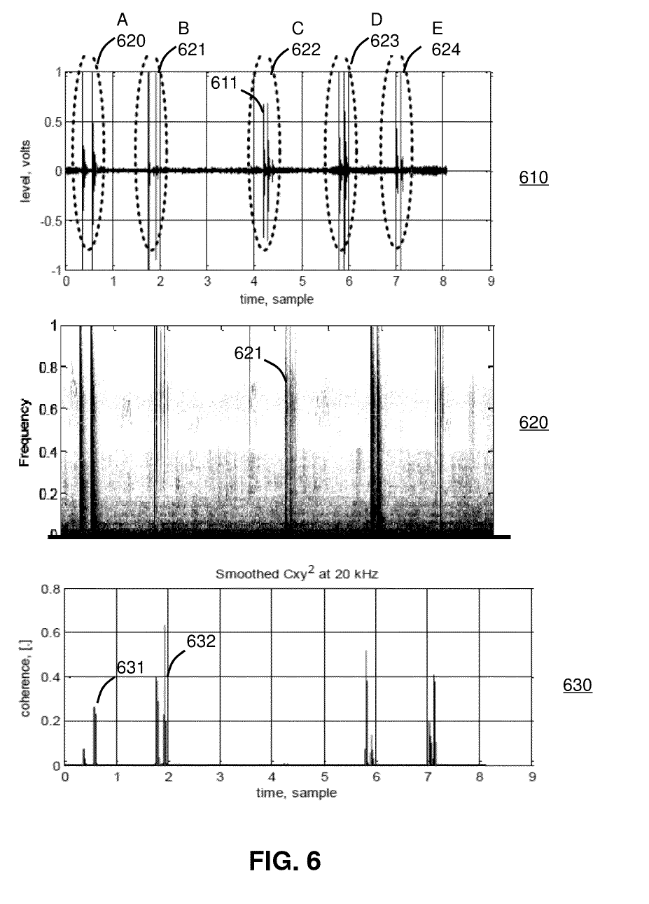

At step 410, a smoothed coherence function is generated from the coherence function, and a peak is calculated from the coherence function in step 412. It may be specifically limited to a “high” frequency band; that is, the smoothed magnitude squared coherence from the frequency band may be between approximately 18 kHz and 20 kHz for analysis. Briefly, FIG. 6 shows a series of coherence functions as will be explained ahead in greater detail. For discussion in the context of method 400, with brief reference to subplot 610 of FIG. 6, one such peak 611 for an exemplary sound event 622 is shown, though multiple peaks spread out over time are herein contemplated. The sound event may be produced by an intentional physical touch by the user or an unintentional airborne sound event, for example, a transient or passing abrupt sound. One purpose of method 400 as explained herein is to differentiate between the sound events.

Returning to method 400 of FIG. 4, the peak is compared at step 414 to a threshold for deciding if the physical contact has occurred. If the peak is not greater than the threshold, a check on whether a timer was made in reference to the sound event is made at step 418. If the timer is not started, the CDS status is set to “negative” at step 422 and the method returns to the start state for step 402. If the timer was previously started, the timer is incremented at step 420 before the CDS status is set to “negative” at step 422. The method similarly returns to the start state for step 402. Notably, one or more peaks may be resolved, which includes evaluating a time window between the one or more peaks. Returning back to step 414, if the peak is greater than the threshold, then a check is made to determine if the timer was previously started at step 424. If the timer was not started, it is reset and started at step 426, and the method proceeds to set the CDS status to “negative” at step 422 and proceed back to start at step 402.

Briefly, the method steps 428 to 440 are specific for determining the CDS state. Upon completion of these steps, the contact detection status (CDS) is either set to a negative value for de-bouncing if the time window is less than a previous time window, otherwise the contact detection status is set to a positive value peaks (timer value). Essentially, if the peak value is less than the threshold value, then a “negative” status for the contact detection is assigned, otherwise a candidate “positive” status is assigned. If the event time of this latest candidate “positive” status time is less than a threshold time of a previous “positive” status time (e.g. 0.01 seconds) then the contact detection status is set to “negative” due to “switch bouncing”, otherwise the contact detection status is set to “positive”.

The CDS determination starts at step 428, wherein, if the timer was previously started, the processor determines the inter-onset interval (101) between peaks. If the debounce inter-onset time (IOT) is less than a predetermined threshold IOT (storage 432) at step 430 then the peak is ignored and the timer is incremented at step 434. If the IOT is not less than the predetermined 10T, then at step 436, a comparison is made to determine if the IOT is greater than a predetermined low IOT threshold but greater than a predetermined higher IOT threshold. These IOT thresholds are retrieved from memory storage. 438. If the outcome of step 436 is NO, then the timer is stopped and reset at step 440. If however the outcome of step 436 is YES then the CDS status is set to “positive” at step 442. The timer is thereafter stopped and reset at step 444 and the method 400 returns to the start state at step 402, to continually scan for new peaks as they are determined in real-time.

In one arrangement, the contact detection status (CDS) is determined by the number of user taps, for example: a single tap if there is a single coherence peak with no other peak within a determined time period (e.g. 5 seconds); a double, triple etc tap is there are two, three etc positive peaks within a determined time period (e.g. 5 seconds). The processor counts the number of the contact detection status events for positive values, and differentiates between a single tap and a double tap from analysis of the contact detection status if the number is within a time period.

FIG. 5 shows an exemplary squared coherence between two microphones at different frequencies and different microphone spacings (i.e. the distance between microphone diaphragms) in a diffuse sound field when the medium is air (top) or butyl rubber (lower), estimated according to the equation below:

$${γ}_{pp}^{2} ( ω , r ) = {( \frac{sin ( ω r / c )}{ω r / c} )}^{2} ,$$

Where w=radian frequency, r=microphone spacing, c=speed of sound. Note that this assumes a diffuse sound field, which would not necessarily be true for sound propagating in a small rubber medium (e.g. an earphone body), and the sound source in an air medium would need to be further from the microphones than the reverberant radius and above the Schroeder frequency for the environment, but these conditions would generally be met for sounds in the real world. Also, for microphones that are mechanically coupled, the coherence between these microphones for airborne sound would increase due to the coupling, but the trends would be similar for the purpose of this analysis.

The trend in the coherence between two microphones, when the sound source is borne via an air path or a solid pathway (in butyl rubber) can be summarized thus:
a. For a fixed frequency, the coherence reduces as microphone spacing increases.
b. For a fixed microphone spacing, the coherence reduces as the sound excitation frequency increases.
c. For a fixed microphone spacing and fixed excitation frequency, the coherence is greater when the medium through which the sound propagates is a solid medium (e.g. rubber) than when the pathway is air.

For instance, we can see that for a microphone spacing of 1 cm, a 16 kHz airborne sound source would give an coherence 0 at 16 kHz, but the squared-coherence would be approximately 0.7 for sound propagated in a solid rubber medium.

The figures in FIG. 6 are used to determine the frequency at which the coherence is analyzed to detect a physical contact (e.g. “tap”) on the body housing the microphones dependent on the microphone spacing. In the exemplary embodiment of an earphone, with a microphone spacing of 1 cm, analyses of the coherence at above 16 kHz therefore provides a good mean to distinguish between airborne excitation and direct excitation (i.e. a physical tap on the earphone body). The material type used to house the microphones will affect the speed of sound in the material (c in the previous equation), thereby affecting the suitable frequency of analysis or threshold value. We can further determine a suitable threshold for determining whether a physical tap has occurred, e.g. if the squared-coherence is greater than 0.5.

Smoothing of the magnitude squared coherence in the preferred embodiment is obtained by convolving the raw magnitude squared coherence with a hanning window of length 4 ms. Smoothing the coherence with such a method will reduce the peaks in the squared coherence, so the threshold value predicted by analysis of FIG. 5 described above will have to be reduced and may need to be determined empirically. In the preferred embodiment, the smoothed magnitude squared coherence from the frequency band between approximately 18 kHz and 20 kHz is analyzed.

Referring still to FIG. 6, the advantages of using a coherence analysis to detect physical contact versus using a level analysis of the microphone signals can clearly be seen. An analysis of coherence has advantages over analysis of the compression wave: Existing systems use a microphone signal level analysis to determine contact on a device. Such “compression wave analysis” systems are prone to false positives created by loud ambient sound sources. Furthermore, such compression wave analysis systems often necessarily requires a loud local sound source to determine contact, e.g. a clap or hard contact pressure against the device surface, which may be non-discrete, uncomfortable or impractical to use.

As shown in subplot 610, one peak 612 for an exemplary sound event 622 is identified, though multiple peaks spread out over time are illustrated. This subplot 610 shows a 17 second recording of an ambient sound microphone signal from one microphone mounted on the body of the earphone 900. The following sound events are shown:
620 Event A: a double clap made by the earphone wearer, approximately 10 cm from the microphone.
621 Event B: a double tap event made by the user tapping on the earphone body.
622 Event C: A double tap made on a table located approximately 30 cm from the earphone.
623 Event D: a second double clap event made by the earphone user, approximately 30 cm from the microphone.
624 Event E: a second double tap event made by the user tapping lightly on the earphone body.

Subplot 620 shows a spectrogram of the waveform from the top subplot 610. The frequency is normalized (i.e. “1”=nyquist frequency, 22 kHz). Subplot 630 shows the smoothed coherence function at approximately 20 kHz. Note that the level of the clap event A shows a much lower peak 631 than the peak 632 for tap event B: i.e. it would be easier to discern the tap events than the clap events, even for the “gentle” tap event E. The table clap event C does not show at all in the coherence analysis. Based on the spectral analysis, using a coherence threshold value of approximately 0.2 can be used to determine if a physical “tap” has occurred, i.e. if the smoothed squared coherence is greater than 0.2, we determine that a physical tap has occurred.

The level analysis of the microphone signal shown in FIG. 6 shows large peaks for the clap events and table tap events, but smaller peak value for the tap events. Therefore, a level analysis may lead to false positives for detecting direct physical contact with the earphone body. Such false positives could be annoying or even dangerous for the earphone sound pass-through embodiment: e.g. considering earphone wearer passing a loud jack-hammer, using a simple level analysis of one microphone signal the system may trigger a false positive and pass through this loud ambient sound to the earphone loudspeaker, startling the user or possibly causing hearing damage from the sudden loud sound exposure.

The advantages of the coherence based analysis described herein over a level analysis improves with microphone spacing, as the coherence for sound events outside the earphone body (e.g. claps or loud ambient sound events) would give a reduced high frequency coherence between the two microphones due to sound scattering (i.e. reflections) in the ambient environment. However, due to the fast speed of sound in a solid body, a direct tap event on the device with two ambient microphones would give a very high coherence: thus enabling robust recognition of the “tap event” from analysis of the smoothed coherence.

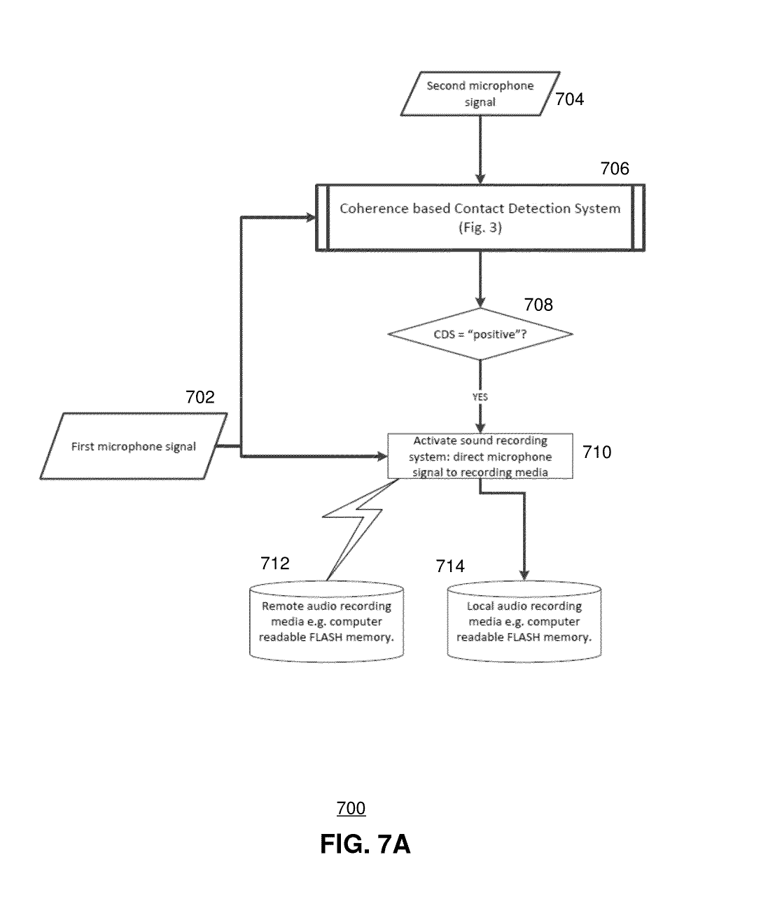

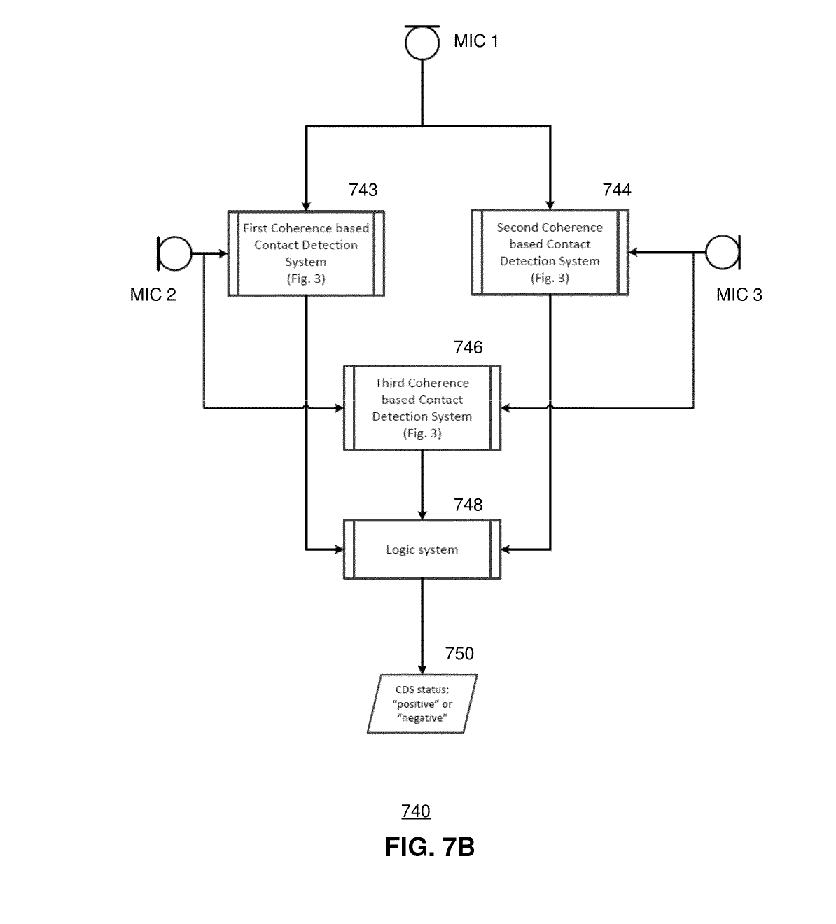

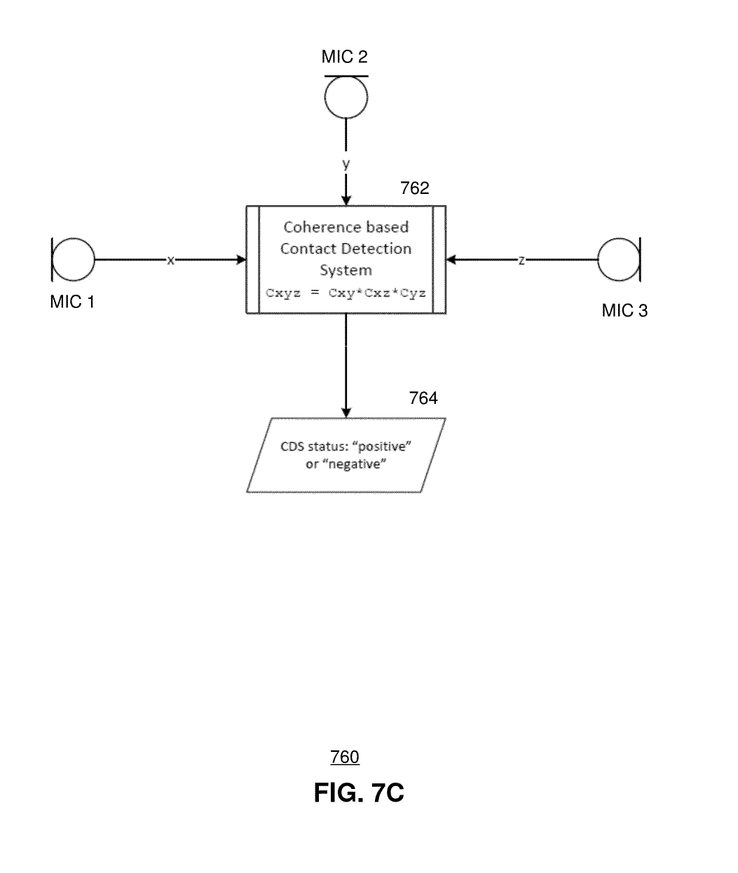

FIG. 7A depicts another flowchart 700 for coherence based contact detection in accordance with another embodiment. In this embodiment, at least one of the ambient sound microphones are directed to a sound recording or analysis system when a sound detected event is determined to have occurred (i.e. used the coherence method). The sound recording or analysis system can comprise an audio codec (e.g. mp3 codec). The recording media system can be local or remote, where the audio to the remote system can be transmitted via radio (e.g. Bluetooth 2.0, Wifi, GSM phone). The location of the system can also be transmitted using a GPS sensor.

The flowchart 700 can start in a state in which the earpiece 900 is in the user's ear and is actively monitoring for a physical contact (e.g, a tapping sound). At step 702 a first microphone signal is received from a first microphone on a device. At step 704, a second microphone signal is received from a second microphone on the device. The coherence function is performed on the first microphone signal and the second microphone signal at step 706 to determine the Contact Detection State (CDS). This is where the system analyzes the coherence function, perform peak detection, and inter-peak timing relations as previously described to determine if a physical contact due to touch occurred on the device, and if so, providing a change to at least one parameter setting on the device responsive to determining the physical contact occurred. In this embodiment, based on the CDS state at step 706, the system will proceed to activate a sound recording at step 710, and direct the microphone signal to a recording media. The device will buffer in the samples, and store to memory, in a compressed or non-compressed format (e.g., PCM, WAV, AIFF, MP3, etc.). This may also include a remote audio recording media (e.g., computer readable FLASH memory) as shown in step 712, or a local audio recording medial (e.g., computer readable FLASH memory) as shown in step 714.

FIG. 7B depicts another flowchart 740 for coherence based contact detection in accordance with another embodiment. In this embodiment, the system is configured for use with three (3) microphones for coherence contact sensing. In this arrangement, the coherence functions and analyses described above with respect to flowchart 300 (and method 400) are applied collectively to paired microphones. Here, a logic unit 748 of the processor combines the contact status of each of the 3 pair-wise systems (743, 744, 746) to determine a single contact status (i.e. positive or negative) at step 750. In one exemplary embodiment, the logic is a simple “AND” logic, i.e. where each of the three pair-wise microphone systems must be positive to give a net positive contact status. A second logic configurations can involve determining a positive contact status if at least 2 out of the 3 pair-wise systems have a positive status. A third configuration is a logic OR, where a positive contact status is determine if at least 1 out of the 3 pair-wise systems have a positive status.

FIG. 7C depicts another embodiment of a three (3) microphone coherence based contact system. This configuration determines at processing block 762 a single coherence value Cxyz (i.e. frequency dependent coherence vector) by multiplying the pair-wise microphone coherences:

Cxyz=CxyCxzCyz

The single coherence value Cxyz can then be used to determine a contact status at processing block 764 using the peak threshold method previously described in detail in the method 400 of FIG. 4. It should be noted that any number of microphones can be used to determine the single coherence value by multiplying the pairwise coherence values of each microphone as illustrated in the above descriptions.

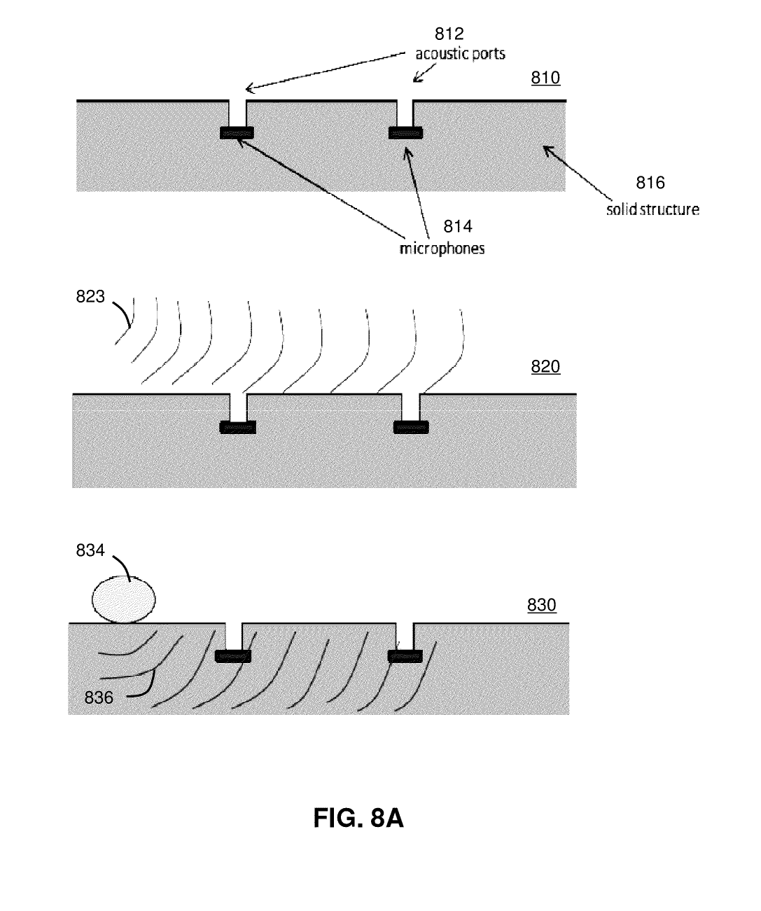

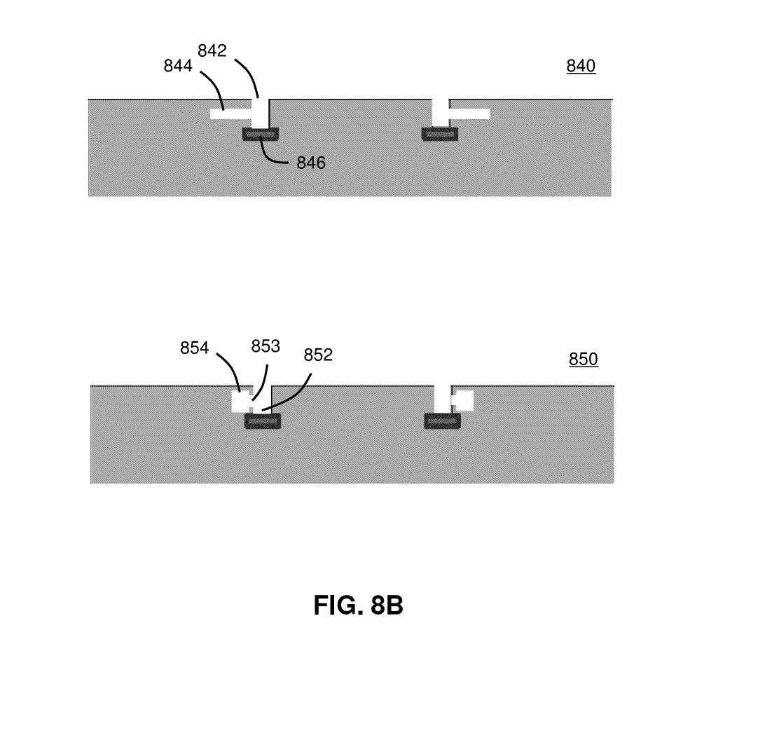

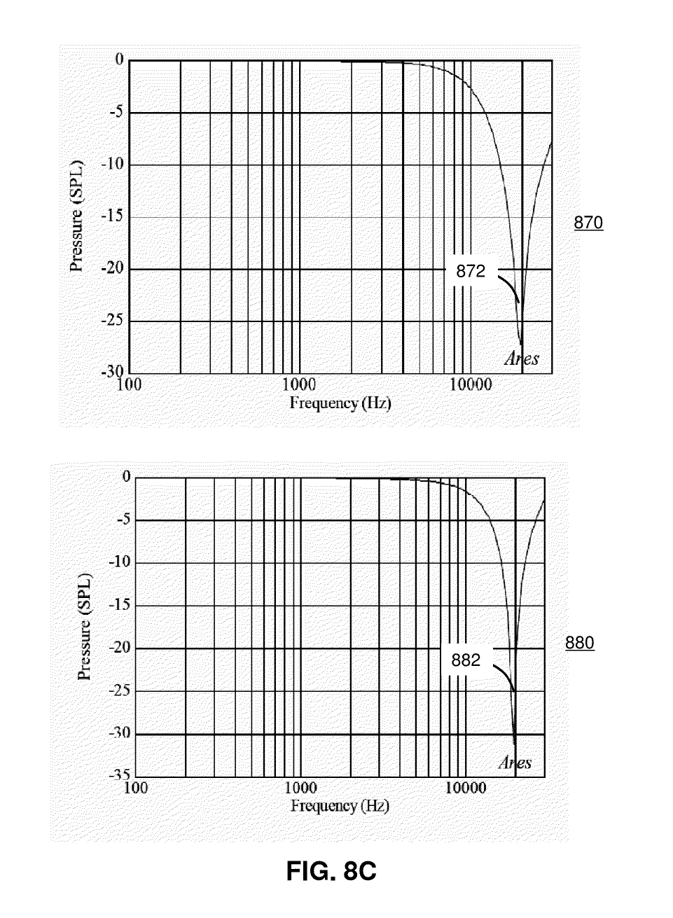

FIG. 8A depicts a body of a device enabled for coherence based contact sensing in accordance with one embodiment. The subplots 810, 820 and 830 illustratively summarize the sound path to two microphones from a “non-contact sound event” originating in the air (or non solid) medium versus a sound event originating from contact with the solid medium housing the microphones. The resulting inter-microphone coherence of air borne sound events versus contact sound events will generally be lower due to sound reflections in the air pathway, as previously discussed.

Subplot 810 illustrates the mechanical coupling arrangement of microphones on the device body. The device is configured to house at least two microphones 814 within a solid structure 816 of the device body and including two acoustic ports 812 for the respective microphones. The acoustic ports 812 channel the sound waves though the solid structure 816 to the microphones 814. The signal path from the acoustic signal travels through the air as illustrated in subplot 820 while the mechanical signal from a finger tap travels through the solid structure and excites the microphone through vibration as illustrated in subplot 830.

Subplot 820 illustrates the propagation of sound waves through the air, for example, from an external sound source 823. From the illustration, it can be seen that sound waves do not significantly transmit through the solid structure 816, but rather over the air, which are then channeled to the microphones 814 through the acoustic ports 812. In contrast, subplot 830 illustrates the propagation of sound waves from a physical contact 834, for example, a finger tapping on the body surface. The finger tab travels through the solid structure as a vibration rather than an acoustic signal traveling through the air. From the illustration, it can be seen that sound waves do propagate within the solid structure 816 more so than over the air, at least, with respect to intensity. Secondly, the characteristics of the wave forms through the solid structure 816 are a function of the material (e.g., porosity, density, etc.) and the spacing of the microphones, and also the acoustic port dimensions.

FIG. 8B depicts the incorporation of “tuned” acoustic channels within a body of a device enabled for coherence based contact sensing in accordance with one embodiment. It should be noted that effect of reduced airborne event coherence versus contact event coherence is especially pronounced at high frequencies. Accordingly, the addition of resonant air channels next to the microphones is herein provided to further reduce coherence for airborne events increasing robustness to false positives from non contact (i.e. airborne) sound events. The coherence of acoustic signals in the 18-20 kHz band due to the airborne sounds can be intentionally degraded (reduced) by placing a structure in the microphone port that significantly reduces the acoustic signal. Two such designs are shown in subplots 840 and 850. As illustrated in subplot 840, the first step is to add a “quarter wavelength” channel 844 off of the main microphone port 842. A channel 844 with a radius of 2 mm and a length of 4.4 mm creates a strong acoustic notch filter around 19 kHz. This additional arrangement provides a “tuned” acoustic channel or cavity next to the microphone inlet and reduces the microphone response to airborne sound at the tuned frequency. Essentially, the acoustic ports (see 812 of FIG. 8A) have been bored and tunneled to create “tuned” acoustic channels; namely, a main microphone port 842 and the channel 844. The addition of the channel (tunnel) 844 near the microphone 846 reduces coherence for airborne sounds and therefore increases system robustness to false positives.

To further mitigate airborne sounds, a volume can be added to the channel. Subplot 850 shows the addition of a volume (cavity) 854 backed to the short channel 853 from the main microphone port 852 to intentionally create a strong acoustic notch filter. The tuning of this acoustic port with channel 853 and volume 854 is such that it resonates to a quarter wavelength of the frequency at which the coherence is measured, which is typically the frequency with a half wavelength approximately equal or greater to the spacing between the two microphones. In the exemplary configuration, by way of the “tuned” acoustic ports, with a microphone spacing of 10 mm, the frequency at which the coherence is analyzed is approximately 19 kHz for the design having channel 853 length 2 mm and width 1 mm and volume 854 with a 16 mm³ volume. (That is, the channel 853 is 1 mm long and 2 mm in diameter, the volume (cavity) is 16 mm3 size to create an acoustic filter notch around 19 kHz.)

FIG. 8C is illustrates frequency responses for the acoustic porting designs shown in FIG. 8B. Subplot 870 of FIG. 8C shows the frequency response of the acoustic model having a short channel as shown in subplot 840 of FIG. 8B as measured at the proximal microphone in response to an external pressure source. Note that the strong notch at 19 kHz will again reduce the acoustic signature by over 20 dB, which will further decrease the acoustic coherence signal in the frequency band of interest and significantly decrease the chance of an acoustic signal causing a false positive detection threshold event. Subplot 880 of FIG. 8C shows the frequency response of the acoustic model having a short channel backed by volume as shown in subplot 850 of FIG. 8B as measured at the proximal microphone in response to an external pressure source. Note that the strong notch at 19 kHz will again reduce the acoustic signature by over 20 dB, which will further decrease the acoustic coherence signal in the frequency band of interest and significantly decrease the chance of an acoustic signal causing a false coherence detection threshold event.

FIG. 9A is an illustration of an earpiece device 900 that can be connected to the system 100 of FIG. 1A for performing the inventive aspects herein disclosed. As will be explained ahead, the earpiece 900 contains numerous electronic components, many audio related, each with separate data lines conveying audio data. Briefly referring back to FIG. 1C, the headset 100 can include a separate earpiece 900 for both the left and right ear. In such arrangement, there may be anywhere from 8 to 12 data lines, each containing audio, and other control information (e.g., power, ground, signaling, etc.)

As illustrated, the earpiece 900 comprises an electronic housing unit 901 and a sealing unit 908. The earpiece depicts an electro-acoustical assembly for an in-the-ear acoustic assembly, as it would typically be placed in an ear canal 924 of a user. The earpiece can be an in the ear earpiece, behind the ear earpiece, receiver in the ear, partial-fit device, or any other suitable earpiece type. The earpiece can partially or fully occlude ear canal 924, and is suitable for use with users having healthy or abnormal auditory functioning.

The earpiece includes an Ambient Sound Microphone (ASM) 920 to capture ambient sound, an Ear Canal Receiver (ECR) 914 to deliver audio to an ear canal 924, and an Ear Canal Microphone (ECM) 906 to capture and assess a sound exposure level within the ear canal 924. The earpiece can partially or fully occlude the ear canal 924 to provide various degrees of acoustic isolation. In at least one exemplary embodiment, assembly is designed to be inserted into the user's ear canal 924, and to form an acoustic seal with the walls of the ear canal 924 at a location between the entrance to the ear canal 924 and the tympanic membrane (or ear drum). In general, such a seal is typically achieved by means of a soft and compliant housing of sealing unit 908.

Sealing unit 908 is an acoustic barrier having a first side corresponding to ear canal 924 and a second side corresponding to the ambient environment. In at least one exemplary embodiment, sealing unit 908 includes an ear canal microphone tube 910 and an ear canal receiver tube 914. Sealing unit 908 creates a closed cavity of approximately 5cc between the first side of sealing unit 908 and the tympanic membrane in ear canal 924. As a result of this sealing, the ECR (speaker) 914 is able to generate a full range bass response when reproducing sounds for the user. This seal also serves to significantly reduce the sound pressure level at the user's eardrum resulting from the sound field at the entrance to the ear canal 924. This seal is also a basis for a sound isolating performance of the electro-acoustic assembly.

In at least one exemplary embodiment and in broader context, the second side of sealing unit 908 corresponds to the earpiece, electronic housing unit 900, and ambient sound microphone 920 that is exposed to the ambient environment. Ambient sound microphone 920 receives ambient sound from the ambient environment around the user.

Electronic housing unit 900 houses system components such as a microprocessor 916, memory 904, battery 902, ECM 906, ASM 920, ECR, 914, and user interface 922. Microprocessor 916 (or processor 916) can be a logic circuit, a digital signal processor, controller, or the like for performing calculations and operations for the earpiece. Microprocessor 916 is operatively coupled to memory 904, ECM 906, ASM 920, ECR 914, and user interface 920. A wire 918 provides an external connection to the earpiece. Battery 902 powers the circuits and transducers of the earpiece. Battery 902 can be a rechargeable or replaceable battery.

In at least one exemplary embodiment, electronic housing unit 900 is adjacent to sealing unit 908. Openings in electronic housing unit 900 receive ECM tube 910 and ECR tube 912 to respectively couple to ECM 906 and ECR 914. ECR tube 912 and ECM tube 910 acoustically couple signals to and from ear canal 924. For example, ECR outputs an acoustic signal through ECR tube 912 and into ear canal 924 where it is received by the tympanic membrane of the user of the earpiece. Conversely, ECM 914 receives an acoustic signal present in ear canal 924 though ECM tube 910. All transducers shown can receive or transmit audio signals to a processor 916 that undertakes audio signal processing and provides a transceiver for audio via the wired (wire 918) or a wireless communication path.

FIG. 9B depicts various components of a multimedia device 950 suitable for use for use with, and/or practicing the aspects of the inventive elements disclosed herein, though is not limited to only those components shown. As illustrated, the device 950 comprises a wired and/or wireless transceiver 952, a user interface (UI) display 954, a memory 956, a location unit 958, and a processor 960 for managing operations thereof. The media device 950 can be any intelligent processing platform with Digital signal processing capabilities, application processor, data storage, display, input modality like touch-screen or keypad, microphones, speaker, Bluetooth, and connection to the internet via WAN, Wi-Fi, Ethernet or USB. This embodies custom hardware devices, Smartphone, cell phone, mobile device, iPad and iPod like devices, a laptop, a notebook, a tablet, or any other type of portable and mobile communication device. A power supply 962 provides energy for electronic components.

In one embodiment where the media device 950 operates in a landline environment, the transceiver 952 can utilize common wire-line access technology to support POTS or VoIP services. In a wireless communications setting, the transceiver 952 can utilize common technologies to support singly or in combination any number of wireless access technologies including without limitation Bluetooth™ Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, EDGE, TDMA/EDGE, and EVDO. SDR can be utilized for accessing a public or private communication spectrum according to any number of communication protocols that can be dynamically downloaded over-the-air to the communication device. It should be noted also that next generation wireless access technologies can be applied to the present disclosure.

The power supply 962 can utilize common power management technologies such as power from USB, replaceable batteries, supply regulation technologies, and charging system technologies for supplying energy to the components of the communication device and to facilitate portable applications. In stationary applications, the power supply 962 can be modified so as to extract energy from a common wall outlet and thereby supply DC power to the components of the communication device 950.

The location unit 958 can utilize common technology such as a GPS (Global Positioning System) receiver that can intercept satellite signals and there from determine a location fix of the portable device 950.

The controller processor 960 can utilize computing technologies such as a microprocessor and/or digital signal processor (DSP) with associated storage memory such a Flash, ROM, RAM, SRAM, DRAM or other like technologies for controlling operations of the aforementioned components of the communication device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions of the relevant exemplary embodiments. Thus, the description of the invention is merely exemplary in nature and, thus, variations that do not depart from the gist of the invention are intended to be within the scope of the exemplary embodiments of the present invention. Such variations are not to be regarded as a departure from the spirit and scope of the present invention.

What is claimed is:

1. A method for acoustical switching suitable for use with a microphone enabled electronic device, the method comprising the steps of:
capturing a first microphone signal from a first microphone on a device;
by way of a processor on, or operatively coupled to, the device communicatively coupled to the first microphone:
analyzing the first microphone signal for a contact event versus a non-contact event; and
directing the electronic device to switch a processing state responsive to a detection of either the contact event or non-contact event.

2. The method of claim 1, wherein the processing state responsive to detecting the contact event comprises at least one of performing a user interface action, a command response, an automatic interaction or a recording.

3. The method of claim 1, wherein the processing state responsive to detecting the non-contact event comprises at least one of performing a voice communication, a data communication, an event detection, a speech recognition, a key word detection, or an SPL measurement.

4. The method of claim 1 configured for contact sensing suitable for use with the microphone enabled electronic device, further comprising the steps of:
capturing a second microphone signal from a second microphone on the device;
by way of the processor on the device communicatively coupled to the first microphone and the second microphone:
performing a coherence function on the first microphone signal and the second microphone signal;
analyzing the coherence function to determine if a physical contact due to touch occurred on the device; and
providing a change to at least one parameter setting on the electronic device responsive to determining the physical contact occurred,
wherein the first microphone and the second microphone are acoustical-mechanically coupled together on the electronic device.

5. The method of claim 4, further comprising discriminating between the physical contact with a high inter-microphone coherence and an airborne event with a low inter-microphone coherence.

6. The method of claim 4, further comprising
generating a smoothed coherence function from the coherence function;
resolving a peak in the smoothed coherence function;
comparing the peak in the smoothed coherence function to a threshold; and
deciding the physical contact has occurred if the peak is greater than the threshold.

7. The method of claim 6, further comprising
resolving one or more peaks in the coherence function;
evaluating a time window between the one or more peaks;
setting a contact detection status to a negative value for de-bouncing if the time window is less than a previous time window, otherwise setting the contact detection status to a positive value.

8. The method of claim 7, further comprising
counting a number of the contact detection status events for positive values; and
differentiating between a single tap and a double tap from analysis of the contact detection status if the number is within a time period.

9. The method of claim 4, wherein the coherence function is a function of the power spectral densities, Pxx(f) and Pyy(f), of x and y, and the cross power spectral density, Pxy(f), of x and y, as:
$${C}_{xy} ( f ) = \frac{{\vert {P}_{xy} ( f ) \vert}^{2}}{{P}_{xx} ( f ) {P}_{yy} ( f )}$$

10. The method of claim 4, wherein a length of the power spectral densities and cross power spectral density of the coherence function are within 2 to 5 milliseconds.

11. The method of claim 4, wherein a time-smoothing parameter for updating the power spectral densities and cross power spectral density is within 0.2 to 0.5 seconds.

12. The method of claim 4, further comprising:
tuning a cavitational acoustic resonance by way of resonant air channels; and
reducing sensitivity of the coherence function to an airborne event from the tuned cavitational acoustic resonance of the first and second microphone signals.

13. The method of claim 12, further comprising
producing a spectral notch specific to the airborne sound event by shaping the resonant air channel to decrease the coherence function for the airborne sound in a frequency band of interest.

14. A system for acoustical switching suitable for use with a microphone enabled electronic device, the system comprising:
a first microphone on the device for capturing a first microphone signal;
an acoustic switch communicatively coupled to the first microphone for
analyzing the first microphone signal for a contact event versus a non-contact event; and
directing the electronic device to switch a processing state responsive to a detection of either the contact event or non-contact event.

15. The system of claim 14, wherein the processing state, by way of a processor on, or operatively coupled to the device, responsive to detecting the contact event comprises at least one of performing a user interface action, a command response, an automatic interaction or a recording.

16. The system of claim 14, wherein the processing state, by way of a processor on, or operatively coupled to the device, responsive to detecting the non-contact event comprises at least one of a voice communication, a data communication, an event detection, a speech recognition or a key word detection.

17. The system of claim 14 configured for contact sensing on a device, further comprising:
a second microphone for capturing a second microphone signal; and
the processor communicatively coupled to the first microphone and the second microphone for:
performing a coherence function on the first microphone signal and the second microphone signal;
analyzing the coherence function to determine if a physical contact due to touch occurred on the device; and
providing a user interface command to the device responsive to determining the physical contact occurred,
wherein the first microphone and the second microphone are acoustical-mechanically coupled together on the device.

18. The system of claim 17, wherein the processor discriminates between the physical contact with a high inter-microphone coherence and an airborne event with a low inter-microphone coherence.

19. The system of claim 17, wherein the processor performs the steps of:
generating a smoothed coherence function from the coherence function;
resolving a peak in the smoothed coherence function;
comparing the peak in the smoothed coherence function to a threshold; and
deciding the physical contact has occurred if the peak is greater than the threshold.

20. The system of claim 17, wherein the processor performs the steps of:
resolving one or more peaks in the coherence function;
evaluating a time window between the one or more peaks;
setting a contact detection status to a negative value for de-bouncing if the time window is less than a previous time window, otherwise setting the contact detection status to a positive value.

21. The system of claim 19, wherein the processor performs the steps of:
counting a number of the contact detection status events for positive values; and
differentiating between a single tap and a double tap from analysis of the contact detection status if the number is within a time period.

22. The system of claim 19, wherein the processor generates a coherence as a function of the power spectral densities, Pxx(f) and Pyy(f), of x and y, and the cross power spectral density, Pxy(f), of x and y, as:
$${C}_{xy} ( f ) = \frac{{\vert {P}_{xy} ( f ) \vert}^{2}}{{P}_{xx} ( f ) {P}_{yy} ( f )}$$

23. The system of claim 19, further comprising:
a first acoustic cavity above the first microphone to create a first resonant air channel;
a second acoustic cavity above the second microphone to create a second resonant air channel;
wherein the processor performs the steps of tunes an acoustic resonance of the first and second microphone signals by way of the first and second resonant air channels; and
reduces a sensitivity of the coherence function to an airborne sound event from the tuned cavitational acoustic resonance of the first and second microphone signals.

24. The system of claim 22, wherein the shaping of the first and second resonant air channels decreases the coherence function in a frequency band of interest and produces a spectral notch specific to the airborne event to reduce false positives.
